(19) United States
(12) Patent Application Publication
(10) Pub. No.: US 2009/0066609 A1
(43) Pub. Date: Mar. 12, 2009

(54) METHOD AND APPARATUS FOR DRIVING PLASMA DISPLAY

(76) Inventors: Akihiro Takagi, Miyazaki (JP); Takashi Sasaki, Miyazaki (JP); Akira Otsuka, Miyazaki (JP); Tetsuya Sakamoto, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/913,072

(22) PCT Filed: Jul. 6, 2005
(86) PCT No.: PCT/JP2005/012477

§ 371 Date: Oct. 30, 2007

(51) Int. Cl. G09G 3/28

(52) U.S. Cl. 345/60

(57) ABSTRACT

A method and an apparatus for driving a plasma display in which supply of a driving waveform to the non-lighting display line of a plasma display screen is stopped while preventing level difference in luminance or instability of operational margin incident to stoppage of driving waveform supply. In the inventive plasma display, a sustain waveform is created and supplied to each display line of the plasma display, and supply of the sustain waveform is stopped for such a display line as no cell is lighted at all in a unit of sub-field thus quickening the clamp period of sustain waveform by using an inductance having an increased L value and shortening the sustain cycle.

### TECHNICAL FIELD

The present invention relates to a method and an apparatus for driving a plasma display. To be more precise, preferred embodiments of the present invention provide a method and an apparatus for driving a plasma display in which supply of a driving waveform to a non-lighting display line is stopped when the non-lighting display line is present on a plasma display screen, while preventing level difference in luminance or instability of an operational margin incident to stoppage of the driving waveform supply.

### BACKGROUND ART

Conventionally, in the technical field of a plasma display apparatus, there is known an apparatus of a method in which a plurality of X electrodes and a plurality of Y electrodes are mutually adjacently placed in a horizontal direction and address electrodes are placed in a vertical direction to form a matrix so that an image is displayed by applying driving waveforms from an X driving circuit, a Y driving circuit and an address driving circuit to a discharge cell at an intersection of the electrodes.

FIG. 8 shows a schematic diagram of a panel and driving circuits of a conventional plasma display apparatus. FIGS. 9 show a structure of a plasma display panel and a sub-field configuration of a driving signal.

Referring to FIG. 8, the plasma display apparatus is composed of a plasma display panel 3, an X driving circuit 4, a Y driving circuit 5, an address driving circuit 6 and a control circuit 7.

The X driving circuit 4 applies a driving waveform to a plurality of X electrodes 11 of the panel 3. The Y driving circuit 5 applies a driving waveform to a plurality of Y electrodes 12 of the panel 3. The address driving circuit 6 applies a driving waveform to a plurality of address electrodes 15 of the panel 3. The control circuit 7 controls the entirety.

According to the panel structure of the plasma display illustrated in FIG. 9, the plurality of X electrodes 11 and Y electrodes 12, a dielectric layer 13 and a protective layer 14 are placed on a surface of a front plate 1. The plurality of address electrodes 15, a dielectric layer 16 and a bulkhead 17 and phosphors 18 to 20 which are orthogonal to the X electrodes 11 and Y electrodes 12 are placed on the surface of a backplane 2. A gas which is a discharge gas is encapsulated in space inside a cell, where a voltage applied to each of the electrodes is controlled so as to discharge electricity by putting the gas in an excited state. The phosphors 18 to 20 convert ultraviolet generated by the discharge to visible light.

The sub-field configuration diagram of the driving signal illustrated in FIG. 9(a) shows the configuration of one field composed of ten sub-fields 21 to 30. FIG. 9(b) shows that a reset period 31, an address period 32 and a sustain period 33 are provided in one sub-field.

A driving method which is supplied to the X electrode, Y electrode and the address electrode in the reset period, the address period and the sustain period of the conventional plasma display panel will be described.

For example, as shown in FIGS. 9(a) and (b), a driving waveform is supplied to the X electrode, the Y electrode and the address electrode in the respective periods which are the result of dividing each of the sub-fields into the reset period, the address period and the sustain period after the field section is divided into the plurality of sub-fields.

In concrete, in the reset period, the X electrode and the address electrode are set at a voltage GND, and a voltage Vw is supplied to the Y electrode to perform reset. In the address period, a voltage Vx is supplied to the X electrode, a voltage −Vy is supplied to the Y electrode, and a voltage Va is supplied to the address electrode to specify the address of a cell to be lighted. In the sustain period, a sustain voltage Vs is alternately supplied to the X electrode and the Y electrode to maintain lighting of the cell.

In the other conventional example, in the reset period, reset may be performed by setting the X electrode and the address electrode at the GND voltage, and supplying the voltage Vw to the Y electrode. In the address period, by supplying the voltage Vx to the X electrode, supplying a voltage −½ Vs to the Y electrode, and supplying the voltage Va to the address electrode, the address of the cell which lights up may be specified. In the sustain period, by alternately supplying sustain voltages ½ Vs and −½ Vs to the X electrode and Y electrode, lighting of the cell may be maintained.

In the plasma display panel as described above, reduction in power consumption is the object, and the following proposals are made.

In order to reduce the power consumption of a plasma display panel, Patent Document 1 discloses the art in which a data detecting part which detects presence or absence of display data in one field period is included in a plasma display panel including a write drive circuit, a scanning drive circuit, a sustaining drive circuit and an erasing drive circuit, and when no display data is present, a sustaining drive timing generating part is controlled in accordance with the output signal of the data detecting part to stop the operation of the above described sustaining drive circuit in the one field period.

In order to significantly reduce the power consumption for ineffective electric charge and discharge for a panel by a sustaining discharge pulse, Patent Document 2 discloses a plasma display apparatus which includes an address driver circuit for writing display data to an address electrode of a plasma display panel, a scan driver circuit for scanning a display electrode, a sustain circuit for causing the display electrode to perform sustaining discharge, and means which monitors presence or absence of write to the display electrode, and stops the discharge sustaining pulse to the display electrode which does not have write, namely, which does not cause display discharge, thereby eliminating ineffective electric charge and discharge to the panel and reducing the power consumption.

In the above described conventional examples, the number of write pixels of each write line is calculated based on the information from the sub-field conversion part, and data of whether write is present or not for each line is stored in the memory which is the storage part for each sub-field. After the write operation is finished, the stored memory data of whether write for each line is present or not is transferred to a shift register of a scan driver circuit before a sustaining operation is performed. Thereby, presence or absence of the write line is detected before the sustaining operation, and the sustaining operation is not performed for the line without write. As a result, power consumption for electric charge and discharge of the electrodes which have nothing to do with write can be made minimum.

Patent Document 1: Japanese Patent Laid-Open Publication No. 11-190984

Patent Document 2: Japanese Patent Laid-Open Publication No. 2005-24607

### DISCLOSURE OF THE INVENTION

In the conventional method for driving a plasma display, when supply of the driving waveform to the display line which does not light on the screen is stopped, the panel capacitance which is seen from the circuit of the plasma display panel changes in accordance with the number of display lines which are stopped. Specifically, the capacitance of the panel itself does not change, but the capacitance charged by supply of the driving waveform is decreased, and thereby, apparent panel capacitance is reduced.

Next, when the sustain waveform is raised, power is supplied from a power recovery circuit by an inductance connected to the panel. Thereafter, by clamping the voltage, a sustain waveform at a predetermined voltage can be obtained. However, as the result that the panel capacitance seen from the circuit changes, LC resonance time of the driving waveform which is supplied to the display line to be lighted changes.

Specifically, as a result that the panel capacitance becomes small when seen from the circuit, the LC resonance time becomes short, and rise of the sustain waveform becomes steep.

As a result that the rise of the sustain waveform becomes steep, discharge timing is quickened. Accordingly, as a result that the discharge timing is quickened, clamp is delayed, and a desired sustaining waveform cannot be obtained.

Accordingly, in the case of stopping the supply of the driving waveform to the display line which does not light on the screen, the sustain waveform is disturbed, different luminance is obtained in the picture image in which the same luminance should be originally obtained as compared with the ordinary case, and a level difference in luminance occurs. Depending on the case, non-lighting may occur due to disturbance of the sustain waveform, and therefore, there arises the problem of the operational margin becoming instable.

The above described Patent Documents 1 and 2 disclose stopping the operation of the sustaining drive circuit (stopping the supply of the sustain waveform) when the panel is not lighted, but cannot solve the above described problems accompanying stoppage of the supply of the sustain waveform.

The present invention is to solve the problem that when supply of a driving waveform to the display line which does not light up on the plasma display screen is stopped, the panel capacitance seen from the circuit of the plasma display panel changes in accordance with the number of display lines which are stopped, the LC resonance time of the driving waveform which is supplied to the display line which lights changes, a level difference in luminance occurs, the clamp time is delayed with respect to the sustain discharge due to the change of the LC resonance time, and therefore, the operational margin becomes instable.

In a method and an apparatus for driving a plasma display of the present invention, in order to solve the above described problem, supply of a sustain waveform is stopped to a display line in which no cell is lighted at all in a unit of sub-field, and adjustment of the timing of a clamp period and a rise waveform which is supplied is performed by using an inductance having an increased L value.

More specifically, the method and apparatus for driving a plasma display of the present invention is mainly characterized in that a sustain waveform is created and supplied to each of the display lines of the plasma display, and supply of the sustain waveform is stopped to a display line in which no cell is lighted at all in a unit of sub-field while timing of the clamp period of the sustain waveform is adjusted by using an inductance having an increased L value.

According to the present invention, by stopping supply of the sustain waveform to a display line in which no cell is lighted at all in a unit of sub-field, power consumption can be reduced, and the problem that the level difference in emissions of a lighting display line and a non-lighting display line occurs, and clamp timing is delayed with respect to the sustain discharge due to change in LC resonance time to make the operational margin instable can be solved.

### BRIEF DESCRIPTION OF THE DRAWINGS

FIG. 1 is a diagram showing driving waveforms of a first embodiment of a plasma display of the present invention;

FIG. 2 is a diagram showing a solution to a conventional problem of the first embodiment of the plasma display of the present invention;

FIG. 3 is a diagram showing driving waveforms of a second embodiment of the plasma display of the present invention;

FIG. 4 is a diagram showing configurations of driving circuits of the first embodiment of the plasma display of the present invention;

FIG. 5 is a diagram showing the driving waveforms of the first embodiment of the plasma display of the present invention and the timing of SW of the driving circuits illustrated in FIG. 4;

FIG. 6 is a diagram showing configurations of driving circuits in the second embodiment of the plasma display of the present invention;

FIG. 7 is a diagram showing the driving waveforms of the second embodiment of the plasma display of the present invention and the timing of SW of the driving circuits illustrated in FIG. 6;

FIG. 8 is a schematic diagram of a panel and driving circuits of a conventional plasma display apparatus; and

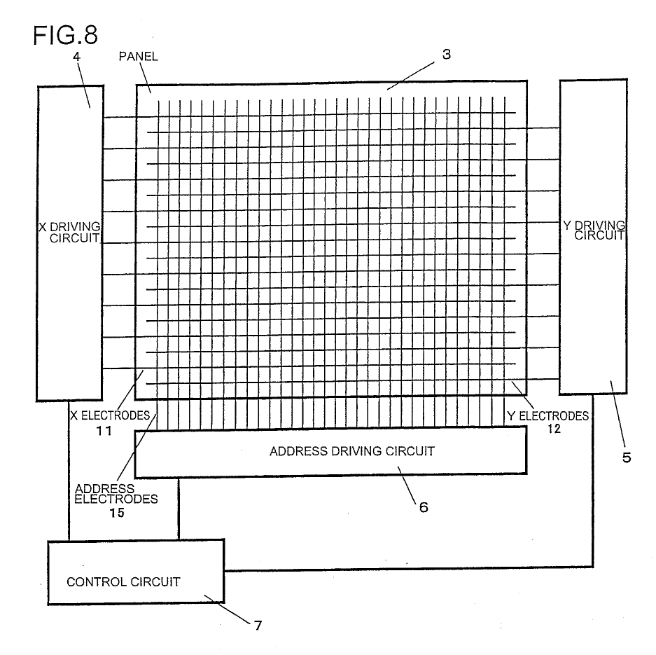

FIGS. 9 are diagrams showing a structure of the conventional plasma display panel and a configuration of a sub-field of a driving signal.

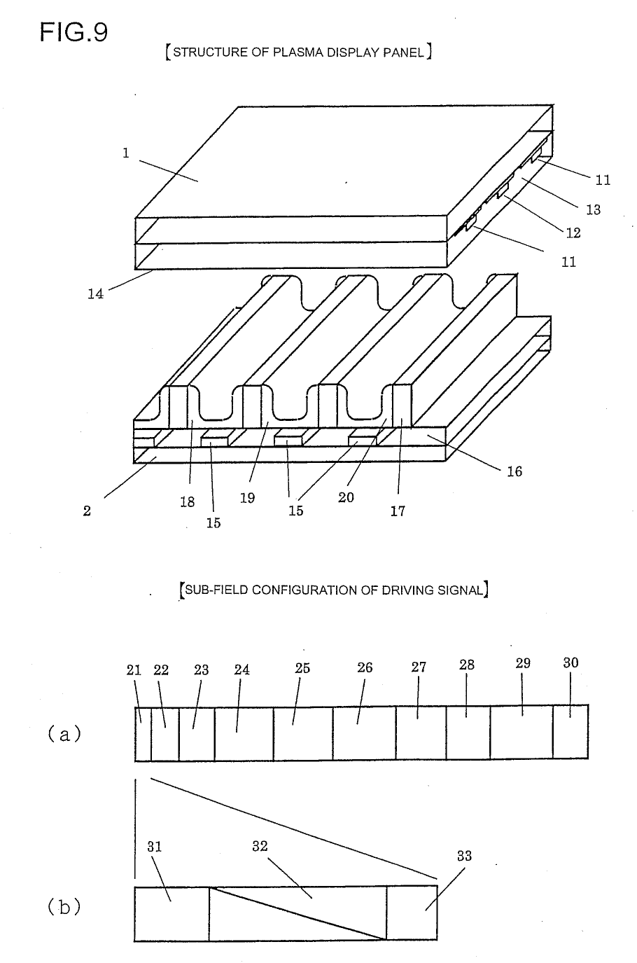

### DESCRIPTION OF SYMBOLS

1 Front plate
2 Backplane
3 Panel
4 X driving circuit
5 Y driving circuit
6 Address driving circuit
7 Control circuit
11 X electrode
12 Y electrode
13, 16 Dielectric layer
14 Protective layer
15 Address electrode
17 Bulkhead
18 to 20 Phosphor
21 to 30 Sub-field
31 Reset period
32 Address period
33 Sustain period

### BEST MODE FOR CARRYING OUT THE INVENTION

Hereinafter, embodiments of the present invention will be described by using the drawings.

### First Embodiment

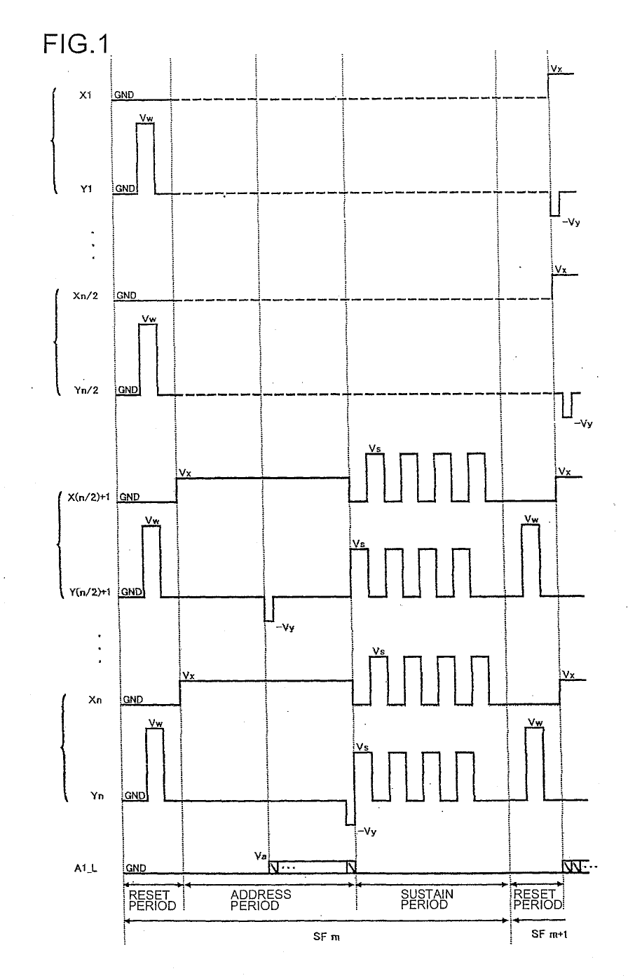

FIG. 1 shows a driving waveform of a first embodiment of a plasma display of the present invention.

The driving waveform illustrated in FIG. 1 shows the case where display lines in which no cell is lighted at all in a unit of sub-field are present in a line 1 to line n/2 (the first half of the line is not lighted). Though not illustrated, a circuit which detects presence or absence of non-display line before application of a sustain waveform is included inside the plasma display by using the conventional art. In the m^{th} subfield SFm, to X electrodes from X1 to Xn/2 and Y electrodes from Y1 to Yn/2, an address voltage is not supplied in an address period, and a sustain voltage is not supplied in a sustain period. Further, in the subsequent reset period, supply of a reset voltage may be stopped.

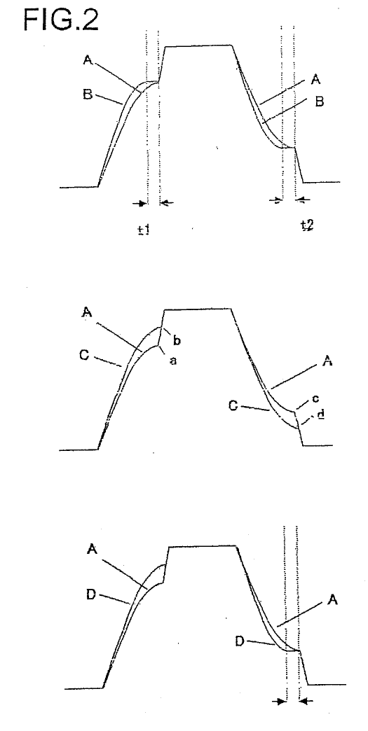

FIG. 2 shows a solution to a conventional problem by the first embodiment of the plasma display of the present invention.

When the sustain voltage is not supplied to some display lines (for example, from the first line to the n/2^{th} line) in the sub-field SFm as shown in FIG. 1, the panel capacitance of the plasma display panel seen from the circuit is in a decreased form, and as shown in the upper drawing of FIG. 2, the sustain waveform changes to a waveform B from a waveform A. The L value shifts from a proper value with respect to the panel capacitance, times t1 and t2 with flat waveforms occur, and the gradient becomes steep. In addition, the clamp timing for keeping a predetermined voltage is delayed with respect to a sustain discharge, and therefore, there exits the problem of the operational margin becoming instable.

In the first embodiment of the plasma display of the present invention, when the panel capacitance reduces by half, by doubling the L value, the waveform A is changed to the waveform C as shown in the drawing in the middle of FIG. 2, and a Q value (Q=ωL/R) is doubled. Therefore, waveform reaching points rise to b from a, and to d from c, whereby the efficiency of charging and discharging power with respect to the panel capacitance is enhanced, and the power consumption is reduced.

By using the L value corresponding to the panel capacitance only at the time of rise or fall of the waveform, the waveform changes from the waveform A to the waveform D and timing of the clamp time is caused to correspond to the supply waveform from the resonance circuit, as shown in the lower drawing of FIG. 2. Thereby, the sustain discharge can be stably performed. By assigning the time reduced to an increase in the number of sustaining discharges, luminance can be enhanced.

The sustain waveforms shown in FIG. 2 are not only used for both the X and Y electrodes, but may be supplied to only the X electrodes or only the Y electrodes. When the sustain waveforms are supplied to only one side, the power reduction rate is reduced but the advantage of simplifying the circuit configuration is obtained.

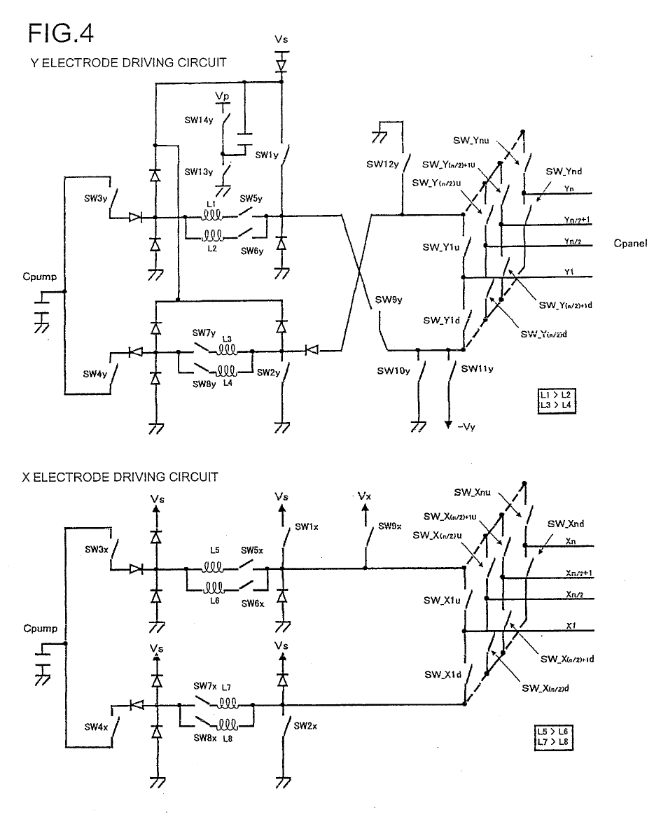

FIG. 4 shows configurations of driving circuits of the first embodiment of the plasma display of the present invention.

In a Y electrode driving circuit, lines Y1 to Yn are connected to panel capacitance Cpanel. When raising the sustain waveform, power is supplied by a power recovery circuit (LC resonance) composed of the panel capacitance Cpanel, inductances L1 and L2 and Cpump. Thereafter, by turning ON SW1y, power is clamped to Vs. When lowering the sustain waveform, power is recovered in the above described power recovery circuit, and by turning ON SW2y, the power is clamped to GND. The same thing applies to the X electrode driving circuit.

In the Y electrode driving circuit in FIG. 4, the display line is selected by SW_Y1u to SW_Ynu and SW_Y1d to SW_Ynd. When the display line is in the first line to n/2^{th} line, the display line is not selected by SW_Y1u to SW_Y(n/2)u and SW_Y1d to SW_Y(n/2)d. When the display line which is not selected is present, the effective value of the panel capacitance Cpanel seen from the circuit becomes small.

When a non-lighting display line is not detected, L2, L4, L6 and L8 which are ordinary L values are used. When the non-lighting display line is detected, L1, L3, L5 and L8 which are large L values are selected by using SW5Y to SW8y and SW5x to SW8x. They are in relation of L1>L2, L3>L4, L5>L6 and L7>L8, respectively. Thereby, when a non-lighting display line is detected, the inductance is switched to the one having a large L value.

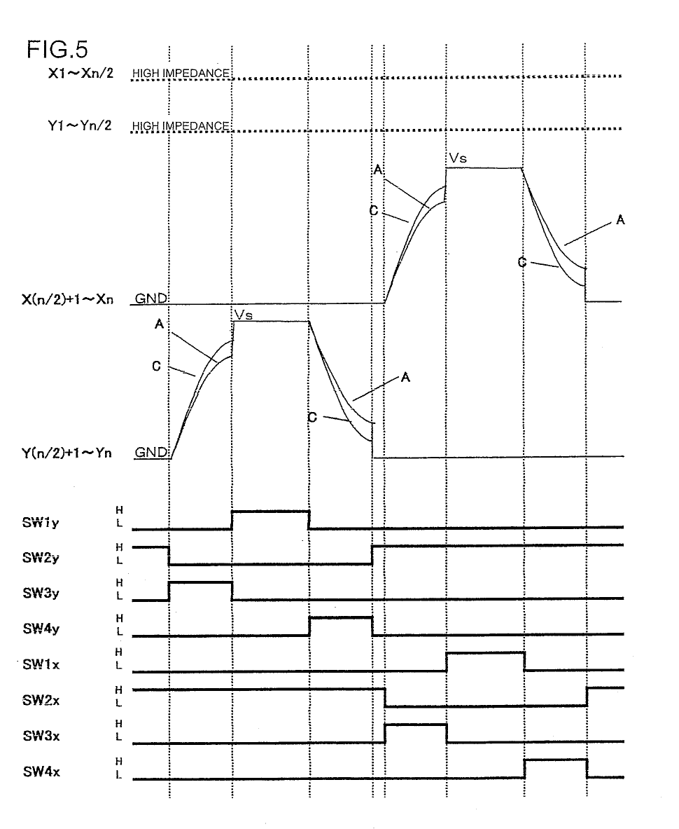

FIG. 5 shows a driving waveform and a solution to the conventional problem in the first embodiment of the plasma display of the present invention.

The driving waveform in FIG. 5 is the result of controlling the timing of SW of the Y electrode driving circuit and the X electrode driving circuit illustrated in FIG. 4.

Referring to FIG. 5, when Cpanel becomes small, L1 and L3 in FIG. 4 are used in the Y electrode driving circuit, and therefore, SW6_{Y} and SW8_{Y} are set at Low, whereas SW5y and SW7y are set at High. In the X electrode driving circuit, L5 and L7 are used, and therefore, SW6x and SW8x are set at Low, whereas SW5x and SW7x are set at High. Thereby, the sustain waveform A is changed to the sustain waveform C, and the power consumption is reduced.

Further, the waveform A is changed to the waveform C, and a sustain discharge can be stably performed. Switching of the above described switches is performed by a control circuit not illustrated together with stoppage of power supply when a non-lighting line is detected.

### Second Embodiment

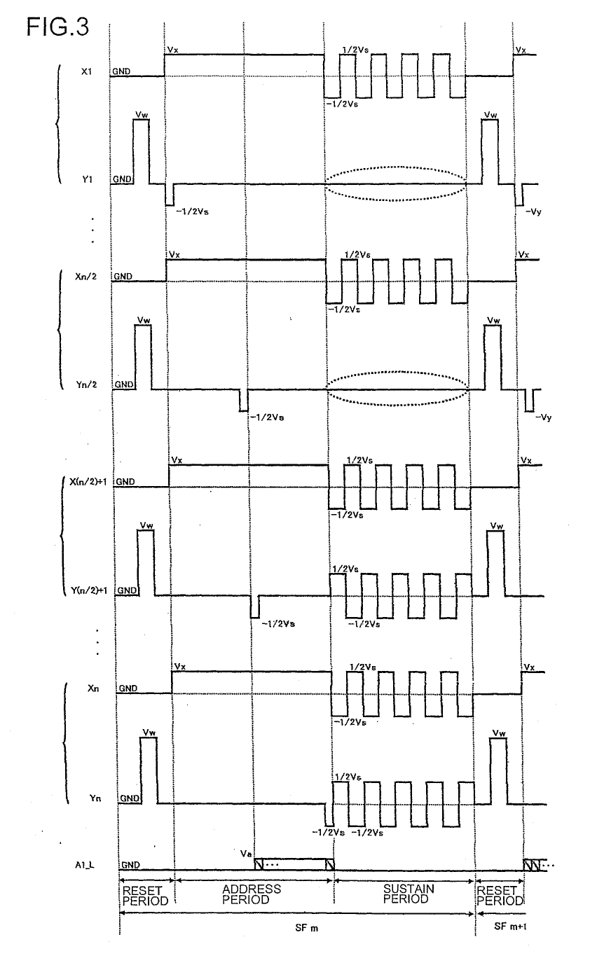

FIG. 3 is a diagram showing a driving waveform of a second embodiment of the plasma display of the present invention.

FIG. 3 shows the driving method in which both the X and Y electrode driving circuits output sustain voltages of +½ Vs and −½ Vs.

In the second embodiment, when the display lines in which no cell is lighted at all in a unit of sub-field are present in the first line to the n/2^{th} line (the first half of the line does not light), only the Y electrodes in the first line to the n/2^{th} line are controlled to be fixed to the GND voltage in the sustain period. In optimization of the LC resonance time, the optimization is performed for only the Y electrodes. As the method for optimizing the LC resonance time, the same method as that of the first embodiment is applied.

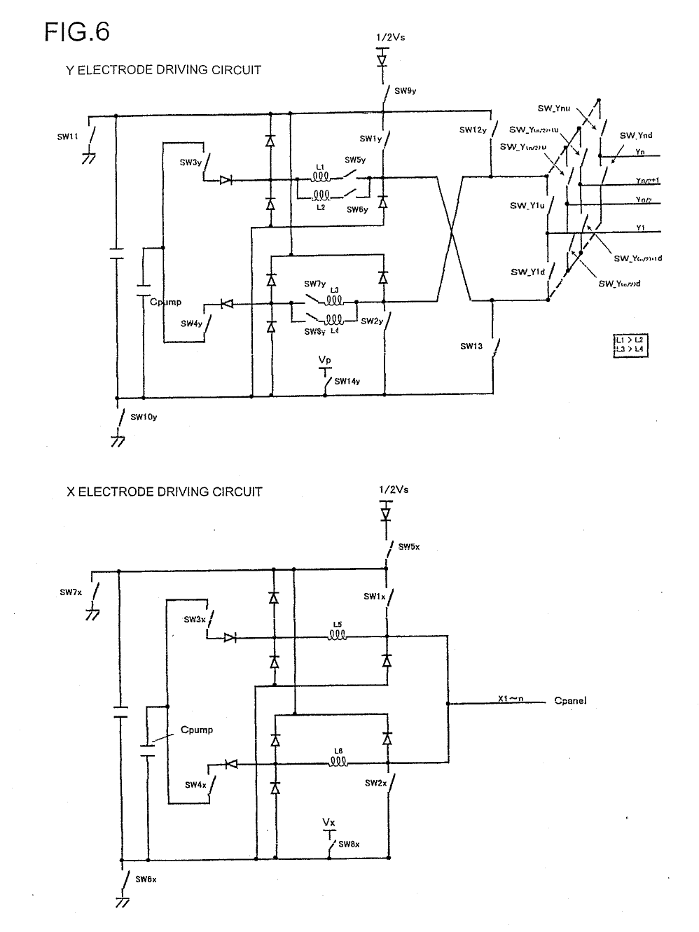

FIG. 6 shows a configuration of the driving circuit of the second embodiment of the plasma display of the present invention.

In the second embodiment illustrated in FIG. 6, when the display lines in which no cell is lighted at all in a unit of sub-field are present in the first line to the n/2^{th} line (the first half of the line does not light), a sustain waveform is supplied to the X electrodes in all of the first line to the n^{th} line, a sustain waveform is supplied to the Y electrodes from Y(n/2)+1 to Yn. Since the panel capacitance decreases, the value L is changed for only Y side in the sustain waveform using the LC resonance.

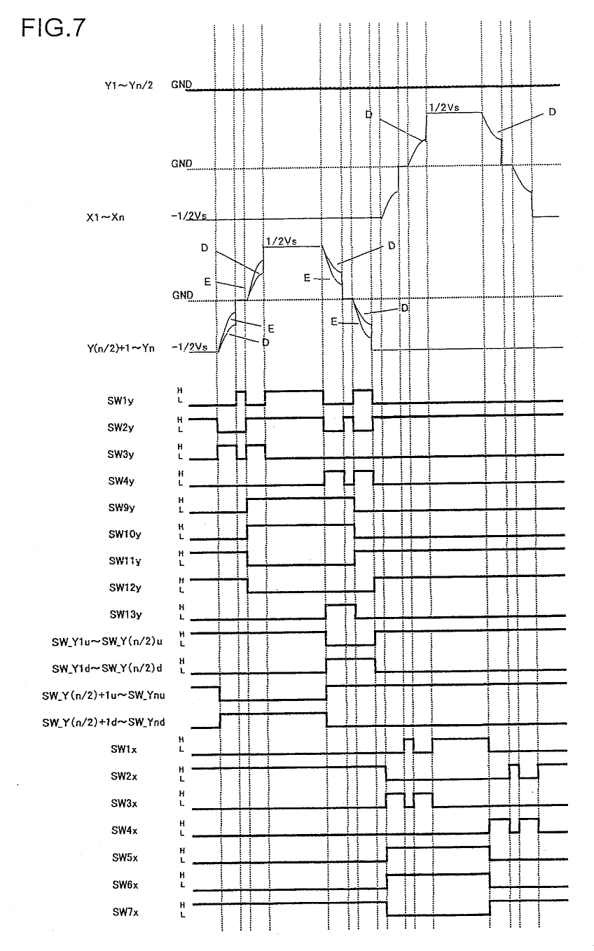

FIG. 7 shows driving waveforms and a solution to the conventional problem of the second embodiment of the plasma display of the present invention.

The driving waveforms of the second embodiment illustrated in FIG. 7 are the result of performing switching control of the L value by using each SW of the Y electrode driving circuit and the X electrode driving circuit in FIG. 6.

Referring to FIG. 7, when Cpanel becomes small, in the Y electrode driving circuit, L1 and L3 are used, and therefore, SW6y and SW8y are set at Low, whereas SW5y and SW7y are set at High for supply to the Y electrodes from Y(n/2)+1 to Yn to change a sustain waveform D to a sustain waveform E.

By changing the waveform D to the waveform E, a sustain discharge can be performed stably. In this embodiment, the L value is changed for only the Y electrode drive circuit, and the circuit scale can be reduced. This is basically the same as the first embodiment.

In the driving method of the present invention, the ALIS method in which a discharge of the Y electrode and one of the X electrodes adjacent to the Y electrode, and a discharge of the Y electrode and the other X electrode are separately performed timewise can also be used in combination.

1. A method for driving a plasma display in which a plurality of X electrodes and Y electrodes are disposed, and an image is displayed by performing a sustaining discharge between the X electrode and the Y electrode by using a resonance circuit, characterized by comprising the steps of:
applying a sustain waveform supplied by the resonance circuit to the X electrode or the Y electrode; and
clamping the sustain waveform to the X electrode and the Y electrode by applying a voltage, and in that
when a non-lighting display line is present, supply of the sustain waveform is stopped to the X electrode or the Y electrode, and an L value of an inductance in the resonance circuit is changed.

2. The method for driving a plasma display according to claim 1, characterized in that
the resonance circuit has a plurality of coils having different L values, and any one of the coils is selected and used depending on presence or absence of a non-lighting display line.

3. The method for driving a plasma display according to claim 1, characterized in that
stoppage of supply of the sustain waveform is performed for only the Y electrode, and the L value of the inductance is changed for only the Y electrode.

4. The method for driving a plasma display according to claim 1, characterized in that
change of the L value of the inductance in the resonance circuit is performed by switching a switch.

5. The method for driving a plasma display according to claim 1, characterized in that
in rise of the sustain waveform, a voltage changes from −½ Vs to ½ Vs.

6. The method for driving a plasma display according to claim 5, characterized in that
a display method of an ALIS method is used.

7. A plasma display device in which a plurality of X electrodes and Y electrodes are disposed, and an image is displayed by performing a sustain discharge between the X electrode and the Y electrode by using a resonance circuit, characterized by comprising:
a power recovery circuit which selects and uses a plurality of inductances, is connected to the X electrode or the Y electrode, and recovers power by a resonance action;
a clamp circuit which clamps a voltage applied to the X electrode and the Y electrode by the power recovery circuit;
detection means which detects presence or absence of a non-lighting display line at a time of displaying a picture image before the sustain discharge; and
changing means which changes the inductance of the power recovery circuit when a non-lighting display line is detected in the detection means.

8. The plasma display device according to claim 7, characterized in that
the power recovery circuit has a plurality of coils, and includes a switch for selecting any one of the coils.

9. The plasma display device according to claim 7, characterized by further comprising:
a control circuit which conducts control to stop supply of a voltage to the X electrode or the Y electrode when a non-lighting display line is detected in the detection means.

10. The plasma display device according to claim 9, characterized in that
display control of an ALIS method is performed.

11. The method for driving a plasma display according to claim 1, characterized in that
when a non-lighting display line is present, supply of any of an address voltage in an address period or a reset voltage after an period of the sustain discharge is stopped.
